(19) United States
(12) Patent Application Publication
(10) Pub. No.: US 2026/0278645 A1
(43) Pub. Date: Sep. 17, 2026

(54) CONTROL DEVICE, CONTROL METHOD, AND NON-TRANSITORY COMPUTER-READABLE RECORDING MEDIUM

(71) Applicant: NEC Corporation, Tokyo (JP)

(72) Inventors: Kazuma KUNIYOSHI, Tokyo (JP); Rui KONDO, Tokyo (JP); Yasuhiko YOSHIDA, Tokyo (JP); Shinnosuke NISHIMOTO, Tokyo (JP)

(73) Assignee: NEC Corporation, Tokyo (JP)

(21) Appl. No.: 19/558,731

(22) Filed: Mar. 6, 2026

(30) Foreign Application Priority Data
Mar. 17, 2025 (JP) 2025-041977

(51) Int. Cl. G06Q 30/0251

(52) U.S. Cl. CPC G06Q 30/0269; G06Q 30/0261

(57) ABSTRACT

In a control device, an avatar attribute detection unit detects an avatar attribute of an avatar in a virtual space. A user attribute detection unit detects a user attribute of a real user who operates the avatar. An attribute match determination unit determines whether the avatar attribute matches the user attribute and outputs a determination result. An advertisement setting unit sets a dedicated advertisement for the avatar in a virtual space based on the determination result.

This application is based upon and claims the benefit of priority from Japanese Patent Application No. 2025-041977, filed on Mar. 17, 2025, the disclosure of which is incorporated herein in its entirety by reference.

### TECHNICAL FIELD

The present disclosure relates to a control device, a control method, and a non-transitory computer-readable recording medium.

### BACKGROUND ART

There is a disclosed technique for estimating an attribute of a user who operates an avatar in a virtual-reality space without requiring any prior information input, and providing an advertisement according to the estimated attribute (e.g., JP 2022-086027 A).

### SUMMARY

A control device according to a first aspect of the present disclosure includes: an avatar attribute detection unit that detects an avatar attribute of an avatar in a virtual space; a user attribute detection unit that detects a user attribute of a real user who operates the avatar; an attribute match determination unit that determines whether the avatar attribute matches the user attribute and outputs a determination result; and an advertisement setting unit that sets a dedicated advertisement for the avatar in a virtual space based on the determination result.

A control method according to a second aspect of the present disclosure includes: detecting an avatar attribute of an avatar in a virtual space; detecting a user attribute of a real user who operates the avatar; determining whether the avatar attribute matches the user attribute and outputting a determination result; and setting a dedicated advertisement for the avatar in a virtual space based on the determination result.

A non-transitory computer-readable recording medium according to a third aspect of the present disclosure causes a control device to execute processing that includes: detecting an avatar attribute of an avatar in a virtual space; detecting a user attribute of a real user who operates the avatar; determining whether the avatar attribute matches the user attribute and outputting a determination result; and setting a dedicated advertisement for the avatar in a virtual space based on the determination result.

### BRIEF DESCRIPTION OF THE DRAWINGS

FIG. 1 is a first block diagram illustrating an example of a configuration of a control device of the present disclosure;

FIG. 2 is a first flowchart illustrating an example of a processing operation of a control device of the present disclosure;

FIG. 3 is a second block diagram illustrating an example of a configuration of a control device of the present disclosure;

FIG. 4 is a second flowchart illustrating an example of a processing operation of a control device of the present disclosure;

FIG. 5 is a third block diagram illustrating an example of a configuration of a control device of the present disclosure;

FIG. 6 is a third flowchart illustrating an example of a processing operation of a control device of the present disclosure;

FIG. 7 is a fourth block diagram illustrating an example of a configuration of a control device of the present disclosure;

FIG. 8 is a relationship diagram illustrating a relationship between terms used by an avatar appearance information detection unit and an evaluation value detection unit;

FIG. 9 is a fourth flowchart illustrating an example of a processing operation of a control device of the present disclosure; and

FIG. 10 is a diagram illustrating an example of a hardware configuration of a control device of the present disclosure.

### EXAMPLE EMBODIMENT

Hereinafter, example embodiments of the present disclosure will be described in detail with reference to the drawings. Note that, in the present disclosure, the drawings are possible to be associated with one or more example embodiments. In addition, each element of the drawings are possible to be applied to one or more example embodiments. In the drawings, the same or corresponding elements are denoted by the same reference numerals, and repeated description will be omitted as necessary for clarity of description.

As used herein, the term “avatar” means a character image serving as a virtual self of a person who accesses a virtual space used for communication within the virtual space. On the other hand, the term “user” isa real person who operates the avatar. That is, the user accesses the virtual space through the avatar. The user is possible to enjoy the virtual space by operating the avatar.

The term “include” and variations thereof are to be understood as open-ended terms meaning “including but not limited to”. The term “based on” is to be understood as “at least partially based on”. The terms “one example embodiment” and “example embodiment” are to be understood as “at least one example embodiment”. The term “another example embodiment” is to be understood as “at least one further example embodiment”.

### First Example Embodiment

### Configuration Example of Control Device

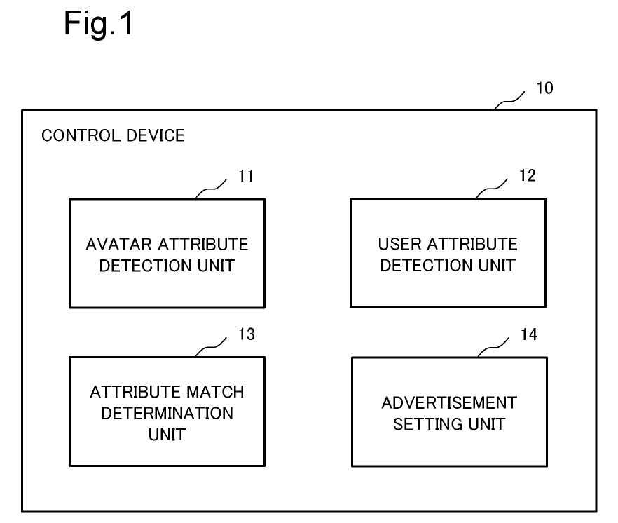

FIG. 1 is a first block diagram illustrating an example of a configuration of a control device of the present disclosure. In FIG. 1, a control device 10 includes an avatar attribute detection unit 11, a user attribute detection unit 12, an attribute match determination unit 13, and an advertisement setting unit 14.

The control device 10 controls an advertisement setting device (not illustrated) for placing an advertisement in the virtual space. The control device 10 may be located inside a general advertisement setting device or outside the advertisement setting device.

The avatar attribute detection unit 11 detects an avatar attribute of an avatar in the virtual space. Specifically, for example, the avatar attribute detection unit 11 detects the gender and age of the avatar in the virtual space as avatar attributes.

The user attribute detection unit 12 detects user attributes of the real user operating the avatar in the virtual space. The user attributes include, for example, the gender and age of the user.

The attribute match determination unit 13 determines whether the avatar attributes and the user attributes match. The match or mismatch determined by the attribute match determination unit 13 is referred to as a determination result. Specifically, for example, the attribute match determination unit 13 determines whether the gender and the age match between the avatar attributes and the user attributes.

The advertisement setting unit 14 sets a dedicated advertisement for the avatar in the virtual space based on the determination result in the attribute match determination unit 13. The dedicated advertisement that is set is, for example, an advertisement in accordance with the age and gender of the user that encourages service use and/or purchase intention. In the virtual space, it is possible to make different advertisements visible to different users. The advertisement setting unit 14 sets a dedicated advertisement for each user.

The advertisement setting unit 14 may cause a dedicated advertisement to be shared with other users. The other users may be friends (close users registered within the virtual space) or nearby avatars/users in the virtual space. In this way, users are possible to exchange information or chat based on the shared dedicated advertisement.

### Operation Example of Control Device

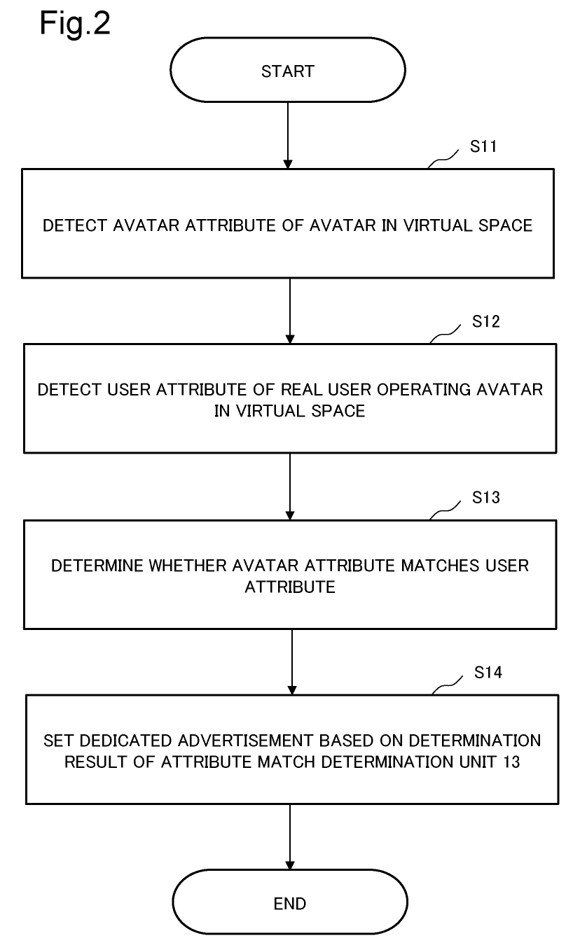

FIG. 2 is a first flowchart illustrating an example of a processing operation of the control device according to the present disclosure.

The avatar attribute detection unit 11 detects avatar attributes of an avatar in the virtual space (step S11).

The user attribute detection unit 12 detects user attributes of the user operating the avatar in the virtual space (step S12).

The attribute match determination unit 13 determines whether the avatar attributes and the user attributes match (step S13).

The advertisement setting unit 14 sets a dedicated advertisement for the avatar in the virtual space based on the determination result in the attribute match determination unit 13 (step S14).

This control device 10 makes it possible to output an advertisement suitable for a user while preventing the advertisement from reflecting any attribute of the user that impairs the user’s sense of immersion in a virtual space. Advertisers are possible to encourage users to use services and/or make purchases through suitable advertisements.

### Second Example Embodiment

### Configuration Example of Control Device

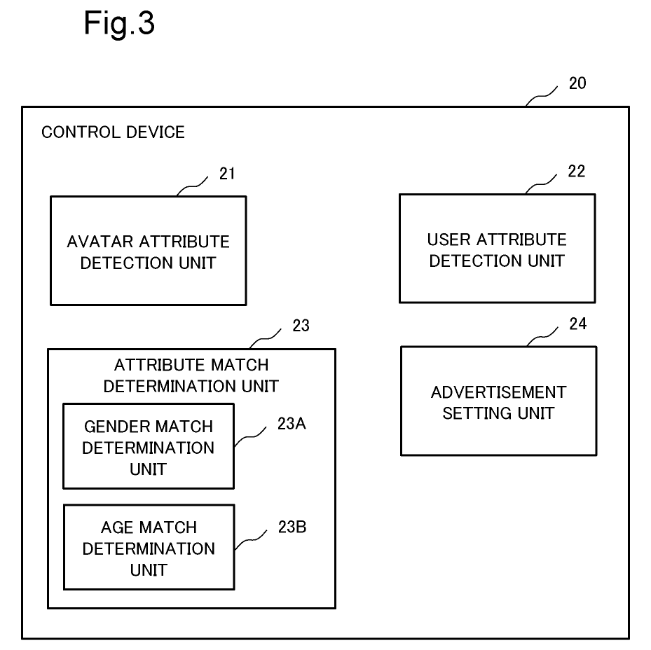

FIG. 3 is a second block diagram illustrating an example of a configuration of a control device according to the present disclosure. A control device 20 includes an avatar attribute detection unit 21, a user attribute detection unit 22, an attribute match determination unit 23, and an advertisement setting unit 24.

The avatar attribute detection unit 21 detects avatar attributes of an avatar in the virtual space. Specifically, the avatar attribute detection unit 21 detects the gender and age of the avatar in the virtual space as the avatar attributes.

The avatar attribute detection unit 21 detects the gender of the avatar by reading the gender of the avatar set within the virtual space. At this time, the avatar attribute detection unit 21 classifies the gender as, for example, male, female, or no gender (assuming specific characters, animals, etc.). The avatar attribute detection unit 21 may add other detailed gender settings set within the virtual space.

The avatar attribute detection unit 21 detects the age of the avatar by reading the age of the avatar set within the virtual space. Specifically, the avatar attribute detection unit 21 detects the age set for the avatar as the age of the avatar. In a case where the age of the avatar is not set and the avatar is a normal male/female avatar, the avatar attribute detection unit 21 may detect the actual age of the user as the age of the male/female avatar. In a case where neither the age of the avatar nor the age of the user is set, the avatar attribute detection unit 21 may detect the age of the avatar as unknown.

The user attribute detection unit 22 detects user attributes of the user operating the avatar in the virtual space. Specifically, the user attribute detection unit 22 detects the gender and age of the real user as the user attributes.

The user attribute detection unit 22 detects the gender of the real user registered as login information when accessing the virtual space. At this time, the gender of the user is classified as, for example, male, female, or unspecified. In a case where another gender is possible to be set as the gender of the real user in the virtual space, another gender may be registered. The user attribute detection unit 22 detects other genders based on the settings of the virtual space.

The user attribute detection unit 22 detects the age of the real user registered as login information when accessing the virtual space. For example, in a case where the user is set to 27 years old, it is detected that the user is 27 years old. Furthermore, the user may register the user’s birth date instead of the age in the virtual space. The user attribute detection unit 22 may detect the age of the user based on the registered birth date by referring to the actual time.

The attribute match determination unit 23 determines whether the avatar attributes and the user attributes match. The match or mismatch determined by the attribute match determination unit 23 is referred to as a determination result. Specifically, the attribute match determination unit 23 determines whether the gender and the age match between the avatar attributes and the user attributes. As illustrated in FIG. 3, the attribute match determination unit 23 includes a gender match determination unit 23A and an age match determination unit 23B.

The gender match determination unit 23A determines whether the avatar gender attribute matches the user gender attribute. In a case where they do not match, the attribute match determination unit 23 determines that the avatar attributes and the user attributes do not match without determining whether the ages match. In addition, also in a case where the user gender attribute is unspecified, the attribute match determination unit 23 similarly determines that the genders do not match without determining whether the ages match.

When the genders match, the age match determination unit 23B determines whether the avatar age attribute matches the user age attribute. Even in a case where the ages are different, the age match determination unit 23B may determine that they match when the age difference falls within a predetermined range. For example, the age match determination unit 23B compares the user age attribute with the avatar age attribute, and determines that they match when they differ by less than 5 years, and determines that they do not match when they differ by 5 years or more. The entity or person who controls the control device 20 or the advertiser may appropriately change the threshold of 5 years for age match determination. For example, in a case of a virtual space or a user attribute for which a 1-year age difference significantly affects the advertisement content, the age match determination unit 23B may determine that there is a mismatch when the difference is 1 year or more, or several months or more. Alternatively, the age match determination unit 23B may make the determination based on the year instead of the age. In this way, the age match determination unit 23B is possible to determine whether the ages match more appropriately based on a pupil’s/student’s grade, an employee’s seniority year, or the like.

In a case where the genders and ages match, the attribute match determination unit 23 outputs a determination result indicating that the avatar attributes and the user attributes match. On the other hand, in a case where the genders do not match, or in a case where the genders match but the ages do not, the attribute match determination unit 23 outputs a determination result that the avatar and user attributes do not match.

The advertisement setting unit 24 sets the dedicated advertisement based on the determination result of the attribute match determination unit 23. Specifically, the advertisement setting unit 24 sets dedicated advertisements of different orientations depending on whether the determination result indicates a match or mismatch.

When the determination result indicates a match, the advertisement setting unit 24 sets the dedicated advertisement based on user attributes. Specifically, the advertisement setting unit 24 sets an advertisement for a real user based on the gender and the age of the user/avatar (referred to as a user-targeted advertisement). For example, the advertisement setting unit 24 sets an advertisement of a product suitable for the gender and the age of the user. For example, the advertisement setting unit 24 may set an advertisement related to shaving for men over 20 years old, or may set an advertisement related to a necklace for women over 20 years old. By setting an advertisement suitable for the real user, it is possible to stimulate demand and consumption related to the user’s real life.

On the other hand, when the determination result indicates a mismatch, the advertisement setting unit 24 does not set an advertisement based on user attributes as the dedicated advertisement. That is, the advertisement setting unit 24 sets an advertisement other than the advertisement based on user attributes. For example, the advertisement setting unit 24 sets a diversity advertisement. A diversity advertisement is an advertisement targeting a relatively wide range of people regardless of gender and age. In a diversity advertisement, priority is given to avoiding an advertisement that is possible to uniquely point to a certain gender or age. Specifically, for example, it may be an advertisement for a popular soft drink, drama, or movie. As a result, in a case where the determination result is a mismatch, the advertisement setting unit 24 is possible to avoid setting an advertisement that impairs the sense of immersion of a user who fully identifies with the avatar in the virtual space. Furthermore, in a case where the user is streaming or the like, it is possible to prevent the user attributes of the real user from being leaked or inferred by viewers, listeners, or the like who have viewed the dedicated advertisement.

### Operation Example of Control Device

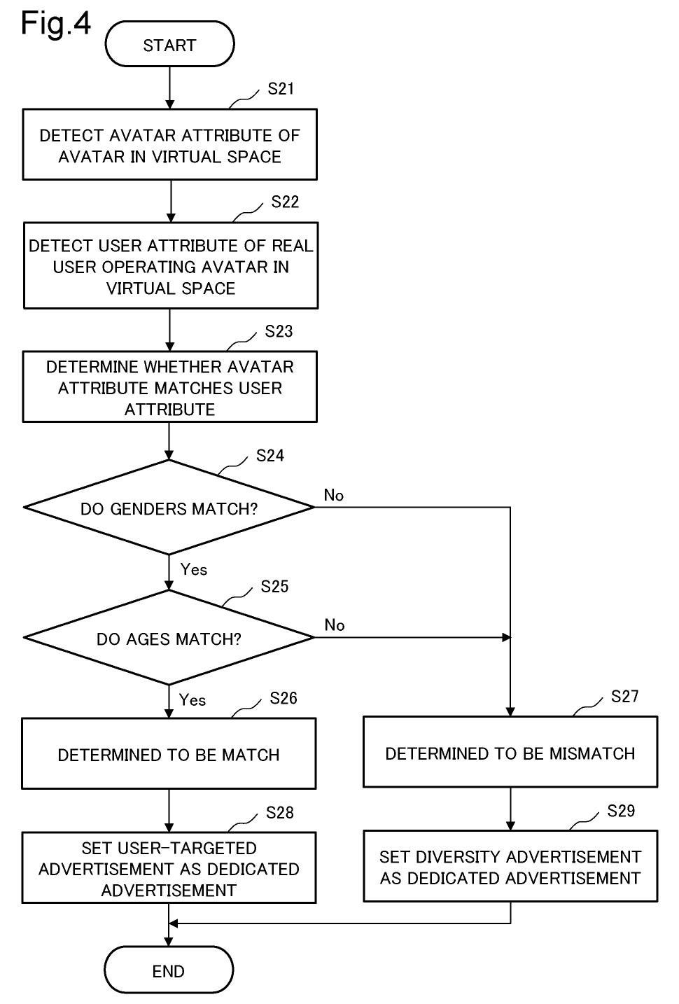

FIG. 4 is a second flowchart illustrating an example of a processing operation of the control device according to the present disclosure.

The avatar attribute detection unit 21 detects avatar attributes of an avatar in the virtual space (step S21).

The user attribute detection unit 22 detects user attributes of the real user operating the avatar in the virtual space (step S22).

The attribute match determination unit 23 determines whether the avatar attributes and the user attributes match (step S23). More specifically, the attribute match determination unit 23 includes a gender match determination unit 23A and an age match determination unit 23B. The gender match determination unit 23A determines whether the avatar gender attribute matches the user gender attribute (step S24).

In a case where the genders match (step S24, Yes), the age match determination unit 23B determines whether the avatar age attribute matches the user age attribute (step S25). When the genders do not match (step S24, No), the attribute match determination unit 23 outputs a determination result indicating a mismatch (step S27).

When the ages also match (step S25, Yes), the attribute match determination unit 23 outputs a determination result indicating a match (step S26). When the ages do not match (step S25, No), the attribute match determination unit 23 outputs a determination result indicating a mismatch (step S27).

The advertisement setting unit 24 sets an advertisement based on the determination result of the attribute match determination unit 23. Specifically, when the attribute match determination unit 23 determines that the attributes match, the advertisement setting unit 24 sets a user-targeted advertisement as a dedicated advertisement (step S28). When the attribute match determination unit 23 determines that the attributes do not match, the advertisement setting unit 24 sets a diversity advertisement as a dedicated advertisement (step S29).

As described above, according to the second example embodiment, in the control device 20, the attribute match determination unit 23 is possible to output the determination result as to whether avatar attributes detected by the avatar attribute detection unit 21 and user attributes detected by the user attribute detection unit 22 match. The advertisement setting unit 24 is possible to set a dedicated advertisement based on the determination result.

The configuration of this control device 20 makes it possible to set an advertisement suitable for a user while preventing the advertisement from reflecting any attribute of the user that impairs the user’s sense of immersion in a virtual space. By setting an advertisement suitable for the user, it is possible to set an advertisement that encourages the user to consume. In addition, it is possible to avoid an advertisement that impairs the user’s sense of immersion who fully identifies with the avatar in the virtual space. Furthermore, in a case where the user is streaming or the like, it is possible to prevent, for example, the user attributes of the real user from being leaked or inferred by viewers, listeners, or the like.

### Third Example Embodiment

### Configuration Example of Control Device

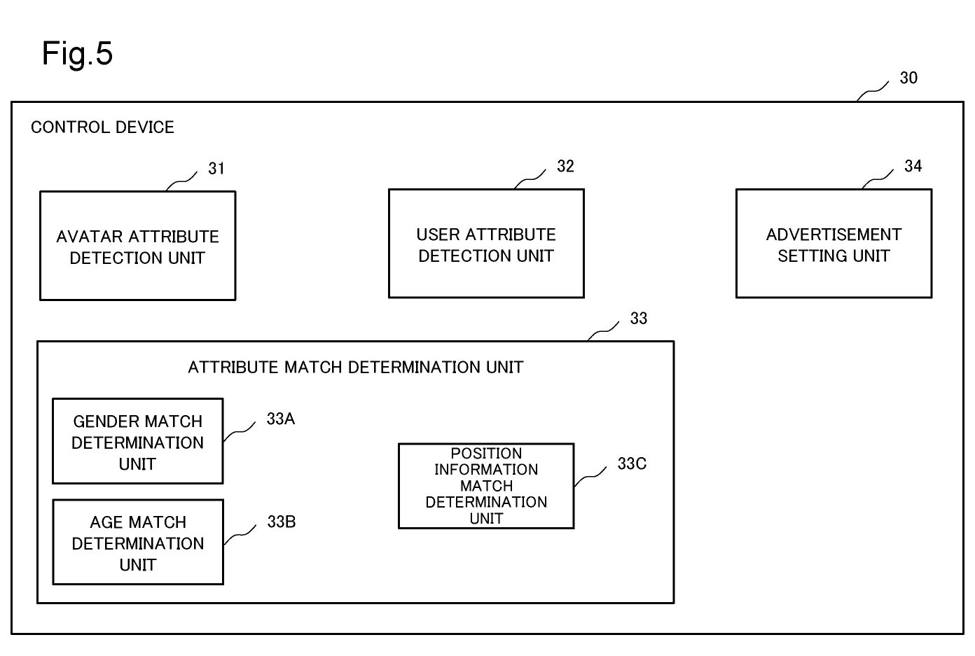

FIG. 5 is a third block diagram illustrating an example of a configuration of a control device according to the present disclosure. A control device 30 includes an avatar attribute detection unit 31, a user attribute detection unit 32, an attribute match determination unit 33, and an advertisement setting unit 34.

The avatar attribute detection unit 31 detects avatar attributes of an avatar in the virtual space. Specifically, the avatar attribute detection unit 31 detects the gender, age, and position information of the avatar in the virtual space as the avatar attributes.

Since the methods of detecting the avatar gender and age attributes are similar to those of the avatar attribute detection unit 21 described in the second example embodiment, redundant description will be omitted.

The position information of the avatar is position information set within the virtual space. For example, it is assumed that a virtual space simulating a region of Japan or other countries in the world is created.

The avatar attribute detection unit 31 detects the position information of the avatar. Specifically, the avatar attribute detection unit 31 detects the position information set in the virtual space based on the position (coordinates) of the avatar in the virtual space. That is, in a virtual space simulating Hokkaido, in a case where the avatar is present in the vicinity of the clock tower in Sapporo city (Sapporo city, Hokkaido), “Sapporo city, Hokkaido” is detected as the position information of the avatar. At this time, the granularity at which the position information is set may be appropriately selected by a platform provider of the virtual space or an administrator using the control device 30. In other words, in a case where the avatar is present near the clock tower in Sapporo city (Sapporo city, Hokkaido), the avatar attribute detection unit 31 may detect the position information of the avatar as “the clock tower in Sapporo city”.

On the other hand, on the platform side of the virtual space, in particular, in a case where the avatar is located in a virtual space in which no arrangement is made regarding position information, the avatar attribute detection unit 31 detects “no position information”.

The user attribute detection unit 32 detects user attributes of the user operating the avatar in the virtual space. Specifically, the user attribute detection unit 32 detects the gender, age, and position information of the real user as the user attributes.

Since the methods of detecting the user gender and age attributes are similar to those of the user attribute detection unit 22 described in the second example embodiment, redundant description will be omitted.

The user attribute detection unit 32 detects the user’s position information. Specifically, the user attribute detection unit 32 detects the position information of a device used by the user to access the virtual space. For example, the user attribute detection unit 32 is possible to acquire the position information of the device by using global positioning system (GPS) positioning. In GPS positioning, the position information of a device used by a user is possible to be acquired by using a satellite. For example, in a case where the device used by the user is located in “Sapporo city, Hokkaido”, the user attribute detection unit 32 detects “Sapporo city, Hokkaido” by GPS positioning or the like.

Furthermore, the user is possible to set an area related to the content of the advertisement in the virtual space as the position information. For example, in a case where a user visits “Sapporo city, Hokkaido” in the virtual space and wants to obtain an advertisement related to “Sapporo city, Hokkaido”, the user sets “Sapporo city, Hokkaido” as the position information. In this case, the user attribute detection unit 32 detects “Sapporo city, Hokkaido” as the position information of the user.

The attribute match determination unit 33 includes a gender match determination unit 33A, an age match determination unit 33B, and a position information match determination unit 33C. The gender and age match determination units 33A and 33B respectively correspond to the gender and age match determination units 23A and 23B described in the second example embodiment, and thus redundant description will be omitted.

In a case where the ages and genders match, the position information match determination unit 33C determines whether the position information of the avatar obtained from the avatar attribute detection unit 31 matches the position information of the user obtained from the user attribute detection unit 32. In addition, the position information match determination unit 33C may determine whether the pieces of position information match within a certain margin, that is, without requiring the exact words to match. For example, it is assumed that the position information of the avatar is “the clock tower in Sapporo city” and the position information of the user is “Sapporo city, Hokkaido”. In such a case, the position information match determination unit 33C may determine that the pieces of position information match.

In a case where the genders, ages, and pieces of position information all match, the attribute match determination unit 33 outputs a determination result indicating that the avatar attributes and the user attributes match. On the other hand, when the genders do not match, when the genders match but the ages do not match, or when the genders and ages match but the pieces of position information do not match, the attribute match determination unit 33 outputs a determination result indicating that the avatar attributes and the user attributes do not match.

In a case where the determination result indicates a match, the advertisement setting unit 34 sets an advertisement directed to the real user based on the gender, age, position information of the user/avatar (referred to as a user-targeted advertisement). For example, the advertisement setting unit 34 sets an advertisement of a product suitable for the gender, age, and position information of the user. For example, the advertisement setting unit 34 may set an advertisement related to interior goods sold exclusively in Hokkaido for men who are in Hokkaido and are 20 years old or older, and set an advertisement related to cosmetics or miscellaneous goods sold exclusively in Hokkaido for women who are in Hokkaido and are 20 years old or older. Compared with the second example embodiment, by incorporating regionality into the advertisement suitable for the real user, it is possible to stimulate demand and consumption related to the user’s real life focusing on the regionality and the positional information. Furthermore, in a case where an advertisement based on the position of an avatar in the virtual space is set, the sense of immersion when the avatar visits a certain region is possible to be further improved.

On the other hand, when the determination result indicates a mismatch, the advertisement setting unit 34 sets the diversity advertisement. In this way, in a case where the avatar is in a region A in the virtual space but the user's device position is in a region B, the advertisement setting unit 34 is possible to prevent the advertisement in the region B from being output as the advertisement. As a result, the advertisement setting unit 34 is possible to avoid setting of an advertisement that is not suitable for the scenery of the region A, and is possible to prevent impairing the sense of immersion of the user who is in the region A within the virtual space.

### Operation Example of Control Device

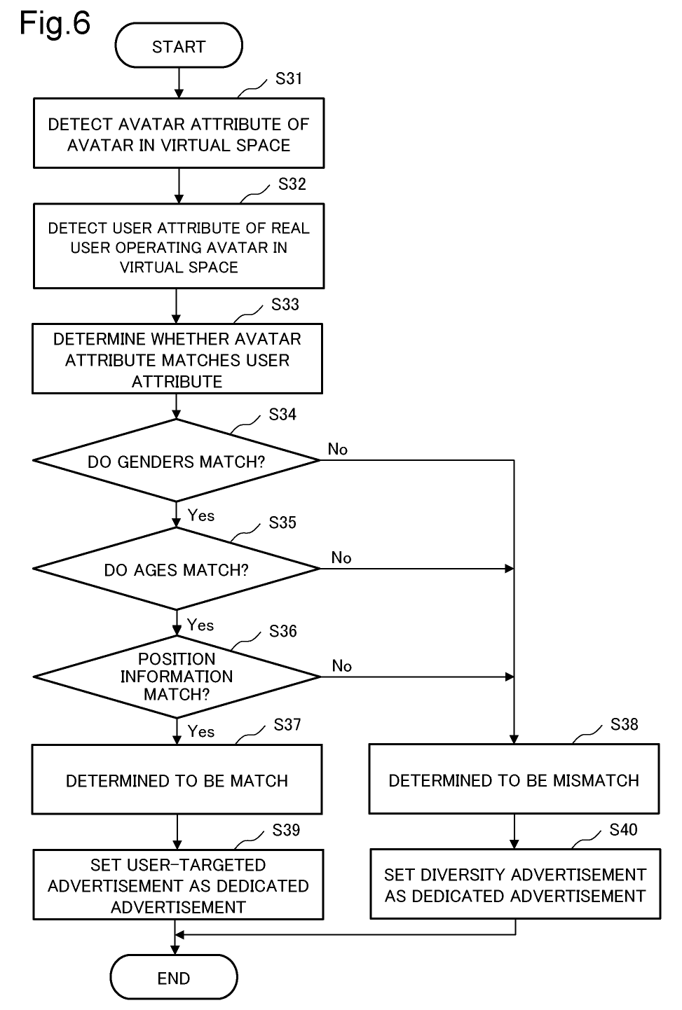

FIG. 6 is a third flowchart illustrating an example of a processing operation of the control device according to the present disclosure.

The avatar attribute detection unit 31 detects avatar attributes of an avatar in the virtual space (step S31).

The user attribute detection unit 32 detects user attributes of the real user operating the avatar in the virtual space (step S32).

The attribute match determination unit 33 determines whether the avatar attributes and the user attributes match (step S33). More specifically, the attribute match determination unit 33 includes a gender match determination unit 33A, an age match determination unit 33B, and a position information match determination unit 33C. The gender match determination unit 33A determines whether the avatar gender attribute matches the user gender attribute (step S34).

In a case where the genders match (step S34, Yes), the age match determination unit 33B determines whether the avatar age attribute matches the user age attribute (step S35). When the genders do not match (step S34, No), the attribute match determination unit 33 outputs a determination result indicating a mismatch (step S38).

Furthermore, in a case where the ages match (step S35, Yes), the position information match determination unit 33C determines whether the avatar position information attribute matches the user position information attribute (step S36). When the ages do not match (step S35, No), the attribute match determination unit 33 outputs a determination result indicating a mismatch (step S38).

When there is a match in position information also (step S36, Yes), the attribute match determination unit 33 outputs a determination result indicating a match (step S37). When there is a mismatch in position information (step S36, No), the attribute match determination unit 33 outputs a determination result indicating a mismatch (step S38).

The advertisement setting unit 34 sets an advertisement based on the determination result of the attribute match determination unit 33. Specifically, when the attribute match determination unit 33 determines that the attributes match (step S37), the advertisement setting unit 34 sets a user-targeted advertisement as a dedicated advertisement (step S39). When the attribute match determination unit 33 determines that the attributes do not match (step S38), the advertisement setting unit 34 sets a diversity advertisement as a dedicated advertisement (step S40).

As described above, according to the third example embodiment, in the control device 30, the attribute match determination unit 33 is possible to output the determination result as to whether avatar attributes detected by the avatar attribute detection unit 31 and user attributes detected by the user attribute detection unit 32 match. The advertisement setting unit 34 is possible to set a dedicated advertisement based on the determination result.

### Fourth Example Embodiment

### Configuration Example of Control Device

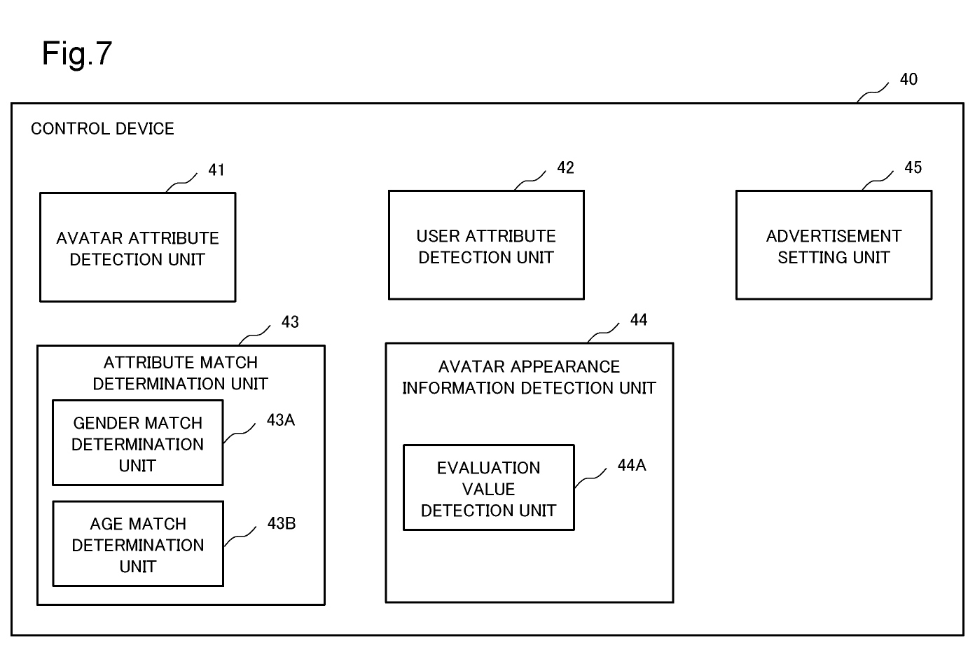

FIG. 7 is a fourth block diagram illustrating an example of a configuration of a control device according to the present disclosure. A control device 40 includes an avatar attribute detection unit 41, a user attribute detection unit 42, an attribute match determination unit 43, an avatar appearance information detection unit 44, and an advertisement setting unit 45.

The avatar attribute detection unit 41, the user attribute detection unit 42, and the attribute match determination unit 43 correspond to the avatar attribute detection unit 21, the user attribute detection unit 22, and the attribute match determination unit 23 described in the second example embodiment, respectively, and thus duplicate description will be omitted.

In the fourth example embodiment, an advertisement for the avatar itself in the virtual space is set based on appearance information of the avatar (referred to as an avatar-targeted advertisement). In the second example embodiment, advertisements for the real user were mainly discussed, but in the fourth example embodiment, advertisements for the avatar in the virtual space are mainly discussed.

The attribute match determination unit 43 determines whether the avatar attributes and the user attributes match. The description for the case where the determination result indicates a match is substantially the same as the description shown in the second example embodiment, and thus redundant description is omitted.

In the following, it is assumed that the determination result of the attribute match determination unit 43 indicates a mismatch. When the determination result indicates a mismatch, the advertisement setting unit 45 is possible to select which of the diversity advertisement and the avatar-targeted advertisement is set as the advertisement. The description for the case where the diversity advertisement is set is substantially the same as the description shown in the second example embodiment, and thus redundant description is omitted. The case where the avatar-targeted advertisement is set as a dedicated advertisement will be described.

The avatar appearance information detection unit 44 detects the appearance information of the avatar in the virtual space. The appearance information is determined based on the appearance of the avatar itself (a person, a character, an animal, an inorganic substance, or the like) and the appearance of items possessed by the avatar (hairstyle, top, pants, bottom, accessories, and/or the like). The avatar appearance information detection unit 44 further includes an evaluation value detection unit 44A. The evaluation value detection unit 44A detects an evaluation value related to the appearance information of the avatar. The evaluation value is a value representing the characteristics or atmosphere of the appearance of the avatar. The evaluation value is determined by an avatar evaluation value related to the appearance of the avatar itself and an item evaluation value related to the appearance of one or more items possessed by the avatar.

In the following description, an example case where how flashy the appearance of the avatar is (referred to as flashiness) is used as the evaluation value will be described. The evaluation value is not limited to the flashiness, and other examples include trendiness, coolness, cuteness, casualness, and formality. The appearance information may be determined based on one or more evaluation values.

The flashiness is determined based on at least one of the flashiness level of the avatar itself and the flashiness level of the items possessed by the avatar. In the following, an example will be described in which the flashiness is determined based on both the flashiness level of the avatar itself and the flashiness level of the items possessed by the avatar. The flashiness level is a reference value indicating how flashy the avatar itself or each item is. For example, ten flashiness levels are provided, ranging from 1 to 10. Among these levels, 1 represents the least flashy and 10 represents the most flashy. The avatars themselves in the virtual space and the items are each assigned with a flashiness level in advance by a platform provider of the virtual space or the like. For example, the flashiness levels may be set as follows: bare skin - 10, a patterned shirt - 9,..., a black suit with stripes - 2, a formal suit - 1, and so on.

The evaluation value detection unit 44A detects the evaluation value of the avatar based on the reference value assigned to the avatar itself and the reference value assigned to each item possessed by the avatar. However, in a case where the avatar possesses no item, the evaluation value detection unit 44A may detect the evaluation value of the avatar based on only the reference value assigned to the avatar itself. The reference value here is the flashiness level. Furthermore, the evaluation value here is the flashiness. Specifically, the flashiness may be the average value, the integrated value, the median value, or the mode value of the flashiness level of the avatar itself and the flashiness levels of the items possessed by the avatar (referred to as an average flashiness level value, an integrated flashiness level value, a median flashiness level value, and a mode flashiness level value, respectively). In the following, a case where the average flashiness level value is used as the flashiness will be described as an example.

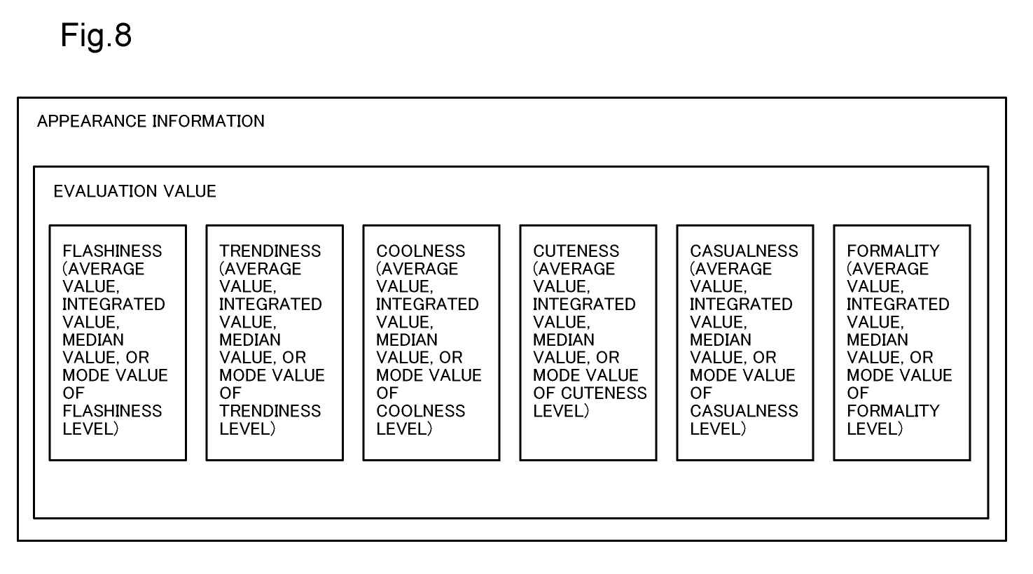

FIG. 8 is a relationship diagram illustrating a relationship between terms used by the avatar appearance information detection unit 44 and the evaluation value detection unit 44A. The appearance information includes one or more evaluation values. In addition, the evaluation value is not limited to the flashiness, and other examples include trendiness, coolness, cuteness, casualness, and formality.

Returning to FIG. 7, the description will be continued. The evaluation value detection unit 44A detects the average flashiness level value. Specifically, first, the evaluation value detection unit 44A calculates the total score of the flashiness level of the avatar itself and the flashiness levels of the items possessed by the avatar, thereby determining the integrated flashiness level value of the avatar. After that, the evaluation value detection unit 44A calculates the average flashiness level value based on the integrated flashiness level value and the total count of the avatar itself and the number of items possessed by the avatar.

As an example, a calculation method in a case will be described where the avatar is set as follows: avatar itself - cat avatar, hairstyle - silver perm, top - tailored jacket, pants - half pants with stripes, accessories - no accessories. For example, each of the flashiness levels is 6 points for the cat avatar, 9 points for silver perm, 6 points for the tailored jacket, 5 points for the half pants with stripes, and 0 points for no accessories. A score of 0 points is exceptionally assigned to no accessories, and the evaluation value detection unit 44A does not include accessories in the total count. That is, the total count is four in this example. The evaluation value detection unit 44A determines that the integrated flashiness level value is 26 points by 6 + 9 + 6 + 5 = 26. After that, the evaluation value detection unit 44A calculates the average flashiness level value as 26/4 = 6.5 points, based on the integrated flashiness level value calculated earlier. Therefore, the evaluation value detection unit 44A determines that the flashiness is 6.5 points from the average flashiness level value of 6.5 points.

The evaluation value detection unit 44A transmits the result that the flashiness is 6.5 points to the avatar appearance information detection unit 44. In this way, the avatar appearance information detection unit 44 is possible to receive the evaluation value as flashiness - 6.5 points. Furthermore, to set a dedicated advertisement, the advertisement setting unit 45 is possible to determine the avatar-targeted advertisement based on the evaluation value received by the avatar appearance information detection unit 44.

The advertisement setting unit 45 sets the dedicated advertisement based on the evaluation value detected by the avatar appearance information detection unit 44. Specifically, the advertisement setting unit 45 compares the reference value of each item determined in advance on the platform side with the evaluation value detected by the avatar appearance information detection unit 44. The advertisement setting unit 45 identifies an item assigned with a reference value close to the evaluation value, and sets an advertisement related to the identified item as a dedicated advertisement. As a result, the advertisement setting unit 45 is possible to set a dedicated advertisement related to an item close to the atmosphere created by the appearance of the avatar. The administrator of the control device is possible to appropriately adjust the range of differences within which the reference value is regarded as close to the evaluation value.

The advertisement setting unit 45 may determine that the reference value and the evaluation value are close to each other when the difference between the reference value and the evaluation value is smaller than a first threshold value. For example, it is assumed that the first threshold value is 1 point. In the above-described example, since the evaluation value (flashiness) is 6.5 points, the advertisement setting unit 45 determines any reference value larger than 5.5 points and smaller than 7.5 points to be close to the evaluation value. Therefore, the advertisement setting unit 45 identifies an item assigned with a reference value larger than 5.5 points and smaller than 7.5 points. The advertisement setting unit 45 sets an advertisement that recommends the identified item as a dedicated advertisement. In this way, the advertiser is possible to encourage the user to purchase an item that does not impair the atmosphere created by the avatar’s fashion.

Furthermore, the advertisement setting unit 45 may compare the reference value of each item determined in advance on the platform side with the evaluation value detected by the avatar appearance information detection unit 44, identify an item assigned with a reference value far from the evaluation value, and set an advertisement related to the identified item as a dedicated advertisement. As a result, the advertisement setting unit 45 is possible to set a dedicated advertisement related to an item that has an atmosphere different from that of the appearance of the avatar. The administrator of the control device is possible to appropriately adjust the range of differences within which the reference value is regarded as far from the evaluation value.

The advertisement setting unit 45 may determine that the reference value and the evaluation value are far from each other when the difference between the reference value and the evaluation value is equal to or greater than a second threshold value. For example, it is assumed that the second threshold value is 3 points. In the above-described example, since the evaluation value (flashiness) is 6.5 points, the advertisement setting unit 45 regards any reference value that is 3.5 points or smaller, or 9.5 points or greater as far from the evaluation value. Therefore, the advertisement setting unit 45 identifies an item assigned with a reference value that is 3.5 points or smaller, or 9.5 points or greater. However, in a case where the value set to the second threshold value exceeds the upper limit or falls below the lower limit of the evaluation value, the advertisement setting unit 45 may identify an item at the upper or lower limit value of the evaluation value. The advertisement setting unit 45 sets an advertisement that recommends the identified item as a dedicated advertisement. In this way, the advertiser is possible to intentionally spoil the atmosphere created by the avatar’s fashion and encourage purchase of a challenging fashion item.

Furthermore, the advertisement setting unit 45 may assess the overall appearance of the avatar and set the dedicated advertisement in a direction that incorporates a more fashion-oriented trend. For example, in the case of a monotone fashion, it is conceivable to suggest “accessories - red bag” as an accent color. In such a case, the advertisement setting unit 45 may set the “accessories - red bag” as the subject of the dedicated advertisement. As a result, it is possible to set a dedicated advertisement not only for items that fit the flashiness of the fashion but also for items for further improving the fashionability.

Note that the advertisement setting unit 45 may determine the item to be suggested (referred to as a suggested item) using artificial intelligence (AI). For example, the administrator of the control device prepares ground truth data for the suggested items according to real-world fashion trend information. The trend information may be analyzed from, for example, sites operated by fashion brands, YouTube (registered trademark), Instagram (registered trademark), and/or the like. Then, the administrator of the control device trains a model using the ground truth data as training data, and generates a trained model for determining whether an item is appropriate as a suggested item. The advertisement setting unit 45 is possible to input the appearance information (e.g., hairstyle, top, pants, bottom, etc.) of the avatar to the trained model and acquire a determination result (whether an item is a suggested item or not) output from the trained model.

### Operation Example of Control Device

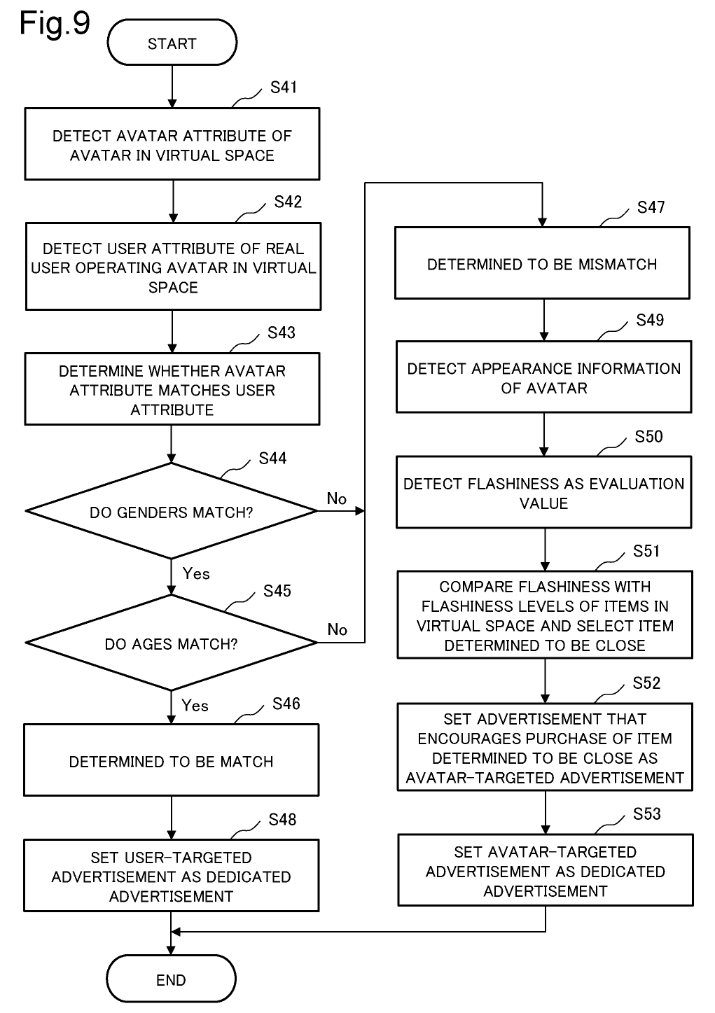

FIG. 9 is a fourth flowchart illustrating an example of a processing operation of the control device according to the present disclosure. In the following, a case where flashiness is used as an example of the evaluation value will be described.

The avatar attribute detection unit 41 detects avatar attributes of an avatar in the virtual space (step S41).

The user attribute detection unit 42 detects user attributes of the real user operating the avatar in the virtual space (step S42).

The attribute match determination unit 43 determines whether the avatar attributes and the user attributes match (step S43). More specifically, the attribute match determination unit 43 includes a gender match determination unit 43A and an age match determination unit 43B. The gender match determination unit 43A determines whether the avatar gender attribute matches the user gender attribute (step S44).

In a case where the genders match (step S44, Yes), the age match determination unit 43B determines whether the avatar age attribute matches the user age attribute (step S45). When the genders do not match (step S44, No), the attribute match determination unit 43 outputs a determination result indicating a mismatch (step S47).

When the ages also match (step S45, Yes), the attribute match determination unit 43 outputs a determination result indicating a match (step S46). The advertisement setting unit 45 sets a user-targeted advertisement as the dedicated advertisement (step S48).

When the ages do not match (step S45, No), the attribute match determination unit 43 outputs a determination result indicating a mismatch (step S47). The avatar appearance information detection unit 44 detects the appearance information of the avatar in the virtual space (step S49).

The avatar appearance information detection unit 44 includes an evaluation value detection unit 44A. The evaluation value detection unit 44A detects the flashiness as the evaluation value (step S50).

The advertisement setting unit 45 compares the flashiness with the flashiness levels of items in the virtual space, and selects an item determined to be close (step S51). Specifically, the advertisement setting unit 45 compares the reference value of each item determined in advance on the platform side with the evaluation value detected by the avatar appearance information detection unit 44. The advertisement setting unit 45 determines that the reference value and the evaluation value are close to each other when the difference between them is smaller than a first threshold value.

The advertisement setting unit 45 sets an advertisement that encourages the purchase of the item determined to be close as an avatar-targeted advertisement (step S52).

The advertisement setting unit 45 sets the avatar-targeted advertisement as the dedicated advertisement (step S53).

With the configuration of the control device 40, it is possible to set an avatar-targeted advertisement in a virtual space based on the appearance information of the avatar. In this way, it is possible to encourage the user to purchase a product or service not for the real user but for an avatar in the virtual space.

### Other Example Embodiment

The configurations in the second to fourth example embodiments may be appropriately and freely combined. That is, a person skilled in the art may implement a disclosure in which the position information match determination unit 33C and the avatar appearance information detection unit 44 are combined.

However, the technique disclosed in this document does not disclose a technology for outputting an advertisement suitable for the user without outputting an advertisement that impairs the user’s sense of immersion in the virtual space.

An object of the present disclosure is to provide a technique for outputting an advertisement suitable for a user while preventing the advertisement from reflecting any attribute of the user that impairs the user’s sense of immersion in a virtual space. It should be noted that the object is merely one of a plurality of objects to be achieved by a plurality of example embodiments disclosed herein. The other objects or problems and novel features will be apparent from the description of the present specification or the accompanying drawings.

The present disclosure provides a control device, a control method, and a non-transitory computer-readable recording medium that is possible to output an advertisement suitable for a user while preventing the advertisement from reflecting any attribute of the user that impairs the user’s sense of immersion in a virtual space.

### Configuration Example of Hardware

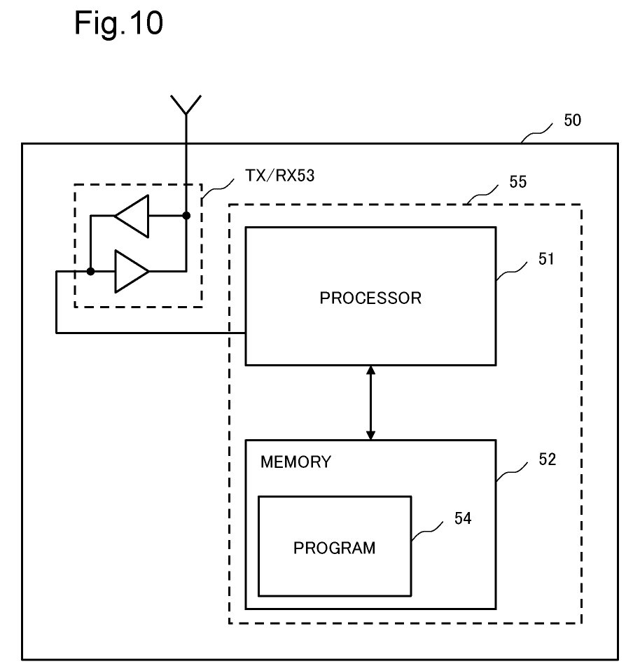

FIG. 10 is a diagram illustrating an example of a hardware configuration of a control device. The control devices 20, 30, and 40 described above may have the hardware configuration illustrated in FIG. 10.

In FIG. 10, a control device 50 may include at least one processor 51 such as a data processor and at least one memory 52 coupled to the processor 51. The control device 50 may further include a transmitter TX/receiver RX 53. The memory 52 may be a non-transitory computer readable medium and may store a program 54. The program 54, when executed in the associated processor 51, may include instructions that enable the control device 50 to operate according to the example embodiments of the present disclosure, for example, to execute the processing flow illustrated in FIGS. 2, 4, 6, or 9. The combination of the at least one processor 51 and the at least one memory 52 may form a processing means 55 adapted to implement various example embodiments of the present disclosure.

In the above-described example embodiments, the configuration of the hardware has been described, but the present disclosure is not limited thereto. The present disclosure is possible to also implement any processing by causing a central processing unit (CPU) to execute a computer program.

In the example shown in FIG. 10, the program is possible to be stored and supplied to the computer using various types of non-transitory computer readable media. The non-transitory computer readable media include various types of tangible storage media. Examples of the non-transitory computer readable media include a magnetic recording medium (for example, a flexible disk, a magnetic tape, or a hard disk drive), a magneto-optical recording medium (for example, a magneto-optical disc), a CD-read only memory (ROM), a CD-R, a CD-R/W, a digital versatile disc (DVD), and a semiconductor memory (for example, a mask ROM, a programmable ROM (PROM), an erasable PROM (EPROM), a flash ROM, or a random access memory (RAM)). The program may be supplied to the computer by various types of transitory computer readable media (transitory computer readable medium). Examples of the transitory computer readable media include electrical signals, optical signals, and electromagnetic waves. The transitory computer readable media is possible to supply the program to the computer via a wired communication line such as an electric wire and optical fibers or a wireless communication line.

The present disclosure is not limited to the above-described example embodiments, and is possible to be appropriately modified without departing from the scope. Furthermore, the present disclosure may be implemented by appropriately combining the example embodiments.

Some or all of the above-described example embodiments may also be described as the following supplementary notes, but are not limited to the following supplementary notes.

### Supplementary Note 1

A control device comprising:

a memory; and

at least one processor coupled to the memory,

the at least one processor performing operations to

detect an avatar attribute of an avatar in a virtual space;

detect a user attribute of a real user who operates the avatar;

determine whether the avatar attribute matches the user attribute and outputs a determination result; and

set a dedicated advertisement for the avatar in a virtual space based on the determination result.

### Supplementary Note 2

The control device according to Supplementary Note 1,

wherein, when the determination result indicates a match, the at least one processor further performs operation to:

set an advertisement based on the user attribute as the dedicated advertisement.

### Supplementary Note 3

The control device according to Supplementary Note 1,

wherein, when the determination result indicates a mismatch, the at least one processor further performs operation to:

set an advertisement being not based on the user attribute as the dedicated advertisement.

### Supplementary Note 4

The control device according to Supplementary Note 1,

wherein the at least one processor further performs operation to:

determine whether there is a match in age and gender according to the avatar and user attributes.

### Supplementary Note 5

The control device according to Supplementary Note 4,

wherein the at least one processor further performs operation to:

determine whether there is a match in position information according to the avatar and user attributes.

### Supplementary Note 6

The control device according to Supplementary Note 1,

wherein the at least one processor further performs operation to:

detect an evaluation value related to appearance information of the avatar, and

set an advertisement based on the evaluation value as the dedicated advertisement.

### Supplementary Note 7

The control device according to Supplementary Note 6,

wherein the evaluation value is determined by an avatar evaluation value related to an appearance of the avatar itself and an item evaluation value related to an appearance of one or more items possessed by the avatar, and

the at least one processor further performs operation to:

identify an item assigned with a reference value whose difference from the evaluation value is smaller than a first threshold value or an item assigned with a reference value whose difference from the evaluation value is equal to or greater than a second threshold value, and sets an advertisement related to the identified item as the dedicated advertisement.

### Supplementary Note 8

A control method including:

detecting an avatar attribute of an avatar in a virtual space;

detecting a user attribute of a real user who operates the avatar;

determining whether the avatar attribute matches the user attribute and outputting a determination result; and

setting a dedicated advertisement for the avatar in a virtual space based on the determination result.

### Supplementary Note 9

A non-transitory computer-readable recording medium storing a program that causes a control device to execute processing including:

detecting an avatar attribute of an avatar in a virtual space;

detecting a user attribute of a real user who operates the avatar;

determining whether the avatar attribute matches the user attribute and outputting a determination result; and

setting a dedicated advertisement for the avatar in a virtual space based on the determination result.

Some or all of the configurations described in Supplementary Notes 2 to 7 dependent on the above-described Supplementary Note 1is possible to also be dependent on Supplementary Notes 8 and 9 by the same dependency relationship as in Supplementary Notes 2 to 7. Some or all of the configurations described as the Supplementary Notes is possible to be similarly dependent on not only the Supplementary Notes 1, 8, and 9, but also various pieces of hardware and software, and various recording means or systems for recording software without departing from the above-described example embodiments.

1. A control device comprising:
a memory; and
at least one processor coupled to the memory,
the at least one processor performing operations to detect an avatar attribute of an avatar in a virtual space;
detect a user attribute of a real user who operates the avatar;
determine whether the avatar attribute matches the user attribute and outputs a determination result; and
set a dedicated advertisement for the avatar in a virtual space based on the determination result.

2. The control device according to claim 1,
wherein, the at least one processor further performs operation to:
set an advertisement based on the user attribute as the dedicated advertisement, when the determination result indicates a match.

3. The control device according to claim 1,
wherein, , the at least one processor further performs operation to:
set an advertisement being not based on the user attribute as the dedicated advertisement, when the determination result indicates a mismatch.

4. The control device according to claim 1,
wherein the at least one processor further performs operation to:
determine whether there is a match in age and gender according to the avatar and user attributes.

5. The control device according to claim 4,
wherein the at least one processor further performs operation to:
determine whether there is a match in position information according to the avatar and user attributes.

6. The control device according to claim 1,
wherein the at least one processor further performs operation to:
detect an evaluation value related to appearance information of the avatar, and
set an advertisement based on the evaluation value as the dedicated advertisement.

7. The control device according to claim 6,
wherein the evaluation value is determined by an avatar evaluation value related to an appearance of the avatar itself and an item evaluation value related to an appearance of one or more items possessed by the avatar, and
the at least one processor further performs operation to:
t identify an item assigned with a reference value whose difference from the evaluation value is smaller than a first threshold value or an item assigned with a reference value whose difference from the evaluation value is equal to or greater than a second threshold value, and sets an advertisement related to the identified item as the dedicated advertisement.

8. A control method comprising:
detecting an avatar attribute of an avatar in a virtual space;
detecting a user attribute of a real user who operates the avatar;
determining whether the avatar attribute matches the user attribute and outputting a determination result; and
setting a dedicated advertisement for the avatar in a virtual space based on the determination result.

9. The control method according to claim 8, further comprising
setting an advertisement based on the user attribute as the dedicated advertisement, when the determination result indicates a match.

10. The control method according to claim 8, further comprising
setting an advertisement being not based on the user attribute as the dedicated advertisement, when the determination result indicates a mismatch.

11. The control method according to claim 8, further comprising
determining whether there is a match in age and gender according to the avatar and user attributes.

12. The control method according to claim 11, further comprising
determining whether there is a match in position information according to the avatar and user attributes.

13. The control method according to claim 8, further comprising
detecting an evaluation value related to appearance information of the avatar, and
setting an advertisement based on the evaluation value as the dedicated advertisement.

14. The control method according to claim 13,
wherein the evaluation value is determined by an avatar evaluation value related to an appearance of the avatar itself and an item evaluation value related to an appearance of one or more items possessed by the avatar, and
identifying an item assigned with a reference value whose difference from the evaluation value is smaller than a first threshold value or an item assigned with a reference value whose difference from the evaluation value is equal to or greater than a second threshold value, and sets an advertisement related to the identified item as the dedicated advertisement.

15. A non-transitory computer-readable recording medium that causes a control device to execute processing of:
detecting an avatar attribute of an avatar in a virtual space;
detecting a user attribute of a real user who operates the avatar;
determining whether the avatar attribute matches the user attribute and outputting a determination result; and
setting a dedicated advertisement for the avatar in a virtual space based on the determination result.

16. The non-transitory computer-readable recording medium according to claim 15 further comprising
setting an advertisement based on the user attribute as the dedicated advertisement, when the determination result indicates a match.

17. The non-transitory computer-readable recording medium according to claim 15, further comprising
setting an advertisement being not based on the user attribute as the dedicated advertisement, when the determination result indicates a mismatch.

18. The non-transitory computer-readable recording medium according to claim 15, further comprising
determining whether there is a match in age and gender according to the avatar and user attributes.

19. The non-transitory computer-readable recording medium according to claim 18, further comprising
determining whether there is a match in position information according to the avatar and user attributes.

20. The non-transitory computer-readable recording medium according to claim 15, further comprising
detecting an evaluation value related to appearance information of the avatar, and
setting an advertisement based on the evaluation value as the dedicated advertisement.
